(19) United States
(12) Patent Application Publication
(10) Pub. No.: US 2008/0133541 A1
(43) Pub. Date: Jun. 5, 2008

(54) Flexible Topic Identification in a Publish/Subscribe System

(75) Inventors: Benjamin Joseph Fletcher, West Yorksire (GB); Martin J. Gale, Hampshire (GB); Jose Emir Garza, Surrey (GB); Gareth Edward Jones, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/835,679

(22) Filed: Aug. 8, 2007

(30) Foreign Application Priority Data
Nov. 30, 2006 (GB) 0623914.9

(51) Int. Cl. G06F 17/30

(52) U.S. Cl. 707/10; 707/E17.032

(57) ABSTRACT

Methods, apparatus and computer programs for flexible topic identification in a publish/subscribe communications network. Publishers and subscribers are able to specify their intentions regarding the topic classification schemes to be used by a publish/subscribe broker during subscription matching, and the broker is responsive to the specified intentions of either or both of the publisher or the subscriber to invoke a respective subscription matching component. The invoked matching components each implement a subscription matching process that is consistent with a specified topic classification scheme.

### TECHNICAL FIELD

The present invention relates to communications within a data processing network, and in particular to apparatus, methods and computer programs implementing the publish/subscribe communications paradigm.

### BACKGROUND OF THE INVENTION

Within a messaging network, messages may be delivered from one data processing system to another via one or more “message brokers” that provide routing and, in many cases, formatting and other services. The brokers are typically located at communication hubs within the network, although broker functions may be implemented at various points within a distributed broker network.

Many message brokers support the publish/subscribe communication paradigm. This involves publishers sending communications that can be received by a set of subscribers who have registered their interest in receiving communications of that type, typically without the publishing application needing to know which subscribers are interested, Publish/subscribe allows subscribers to receive the latest information in an area of interest (for example, stock prices or events such as news flashes or special offers) without having to proactively and repeatedly request that information from each of the publishers.

A typical publish/subscribe environment has a number of publisher applications sending messages via a broker to a potentially large number of subscriber applications located on remote computers across the network. The subscribers register with a broker and identify the categories of information they wish to receive and this information is stored at the broker. In many publish/subscribe implementations, subscribers specify one or more topic names which represent the information they wish to receive. Publishers assign topic names to messages that they send to the publish/subscribe broker, and the broker uses a matching engine to compare the topics of received messages with the stored subscription information for the set of registered subscribers. This comparison determines which subscribers the messages should be forwarded to.

Another known publish/subscribe environment implements a publish/subscribe matching engine on the same data processing system as a subscriber application. Publishers send publications to this system, and the publish/subscribe matching engine determines which publications are of interest to the local subscriber application. In the context of the present invention, the term “publish/subscribe broker” is intended to include a publish/subscribe matching engine that is implemented at an intermediate network node between publishers and subscribers, but the term is also intended to include a publish/subscribe matching engine when implemented on the subscribers data processing system.

Although subscription matching often involves checking topic fields within headers of published messages, the matching may additionally or alternatively involve checking other message header fields or checking message content and filtering messages based on the additional information. For example, a message broker implementing the Java™ Message Service (JMS) typically allows filtering based on message properties (but not based on the application data that is the message content or ‘payload’). A message broker may perform additional functions, such as formatting or otherwise processing received messages before forwarding them to subscribers. (Java and Java-based names are trademarks of Sun Microsystems, Inc.)

A commercially available example of a message broker product that supports the publish/subscribe paradigm and supports filtering based on message properties or message content is IBM Corporation's WebSphere Message Broker, as described in the documents “IBM WebSphere Message Broker Version 6 Release 0—Introduction”, IBM Corporation, July 2006, and “IBM WebSphere Message Broker Version 6 Release 0—Publish/Subscribe”, IBM Corporation, July 2006. (IBM and WebSphere are trademarks of International Business Machines Corporation.)

The publish/subscribe paradigm is an efficient way of disseminating information to multiple users, and is especially useful for environments in which the set of publishers and/or subscribers can change over time and where the number of publishers and/or subscribers can be large. Although some subscriptions are ‘non-durable’ (i.e, remain active only while a subscribing application is connected to the broker), many subscriptions are ‘durable’ and remain active until the subscribing application explicitly unsubscribes. When a ‘durable’ subscriber no longer wishes to receive publications, the subscriber can unsubscribe from the broker (or unsubscribe from a particular topic or set of topics).

Topics are often specified hierarchically, for example using the character string format “root/topicA/topicX” where topicA is one of the available topics in the first level of the hierarchy underneath the root node and topicX is one of the available topics in the second level of the hierarchy underneath topicA, and the ‘/’ character is a separator between the topic names of the different levels of the hierarchy. FIG. 1 shows a simple topic tree in which the first level of the tree underneath the root node has two topics topicA and topicB, and the second level of the tree underneath topicA has a number of topics topicX, topicY and topicZ. A subscriber SUBSCRIBER1 (SUB.1 in FIG. 1) has subscribed to receive messages published on the topic “root/topicA/topicX”, and their subscription is associated with the respective node of the topic tree. The elements of the topic string within a received message are each compared in turn with the set of nodes at the respective level of the topic tree until a node of the tree is identified that matches the received topic string, or it is determined that there is no match. When a match is identified, the publication is forwarded to the subscribers that have registered to receive publications on that topic (subject to checking any filters based on message properties or message content that has been specified within the particular subscriptions).

This hierarchical structure allows publishers and subscribers to specify topics very precisely within published messages and within subscription requests, and allows the topic strings within received messages to be compared with subscriptions using a matching algorithm that iteratively steps through the topic hierarchy.

A problem with conventional hierarchical topic names and the corresponding matching algorithms is that the publishers and subscribers and the publish/subscribe broker must all have knowledge of the topic hierarchy and must all use a consistent expression for the hierarchical topic names. For example, since there is no intuitive reason for preferring ‘Hampshire/weather’ over ‘weather/Hampshire’ in a topic hierarchy (or vice versa) new subscribers must learn the particular hierarchy used by publishers. Similarly, new publishers need to be consistent with the expectations of existing subscribers or they must inform all subscribers of their particular topic hierarchy so that the subscribers can subscribe accordingly.

In the past, this constraint has been accepted by publishers and subscribers, both for proprietary networks within a single company and for inter company publish/subscribe solutions because it seemed essential for the integration of publishers and subscribers and for efficient publish/subscribe broker operation. However, the need for new publishers and subscribers to implement an existing hierarchical topic naming convention may discourage new publishers and/or subscribers from joining the publish/subscribe network.

Some flexibility is achieved using wildcards (for example allowing subscribers to subscribe to ‘weather/*’ (where ‘*’ is a wildcard that can take any value) instead of having to separately subscribe to ‘weather/Hampshire’ and ‘weather/Dorset’ and ‘weather/Surrey’, etc, but that is an example of exploiting knowledge of the hierarchy and does not spare the subscriber from the inconvenience of learning and conforming to the hierarchy. For example, a subscription to ‘UK/weather/*’ would not match a publication on ‘UK/*/weather’.

Lepori et al. “Push communication services: a short history, a concrete experience and some critical reflections”, Studies in Communication Sciences 2/1, 2002, pages 149-164, describes a simplistic alternative approach in which publishers in a publish/subscribe network classify their publications, and subscribing users specify their interests, according to a simple keyword scheme that uses Boolean matching. However, the simple set of keywords proposed by Lepori et al. is not granular enough for the large number of different topics that are found in many publish/subscribe systems. A typical subscriber that specifies a larger number of keywords can be expected to receive too large a proportion of the published messages. For example, a subscriber that specifies a set of keywords using the Boolean operation ‘OR’ (‘UK’ OR ‘Hampshire’ OR ‘weather’), could expect to receive weather information for other countries as well as all published information on topic ‘UK’ and all information on topic ‘Hampshire’. To reduce the number of publications they receive, the subscriber might use the Boolean operator AND, but then a subscription specifying (‘UK’ AND ‘weather’ AND ‘Hampshire’) would miss a publication with topics (‘UK’, ‘weather’). Even with a good understanding of the keyword matching algorithm, a subscriber that defines its subscription sufficiently generally to capture all desired publications is likely to receive a lot of unwanted publications as well.

Therefore, a keyword scheme using Boolean matching is not well suited to subscribers who need to receive all relevant business critical publications but who do not wish to be burdened with a large number of irrelevant publications. To resolve these problems, a skilled reader of Lepori et al. might revert to the greater granularity and precision (and constraints) of a hierarchical topic naming scheme.

### SUMMARY OF THE INVENTION

Provided are methods, apparatus and computer programs for flexible topic identification in a publish/subscribe communications network. Publishers and subscribers are able to specify their intentions regarding the topic classification schemes to be used by a publish/subscribe broker during subscription matching, and the broker is responsive to the specified intentions of either one or both of the publisher and the subscriber, to invoke a respective subscription matching component. The invoked matching components each implement a subscription matching process that is consistent with a specified topic classification scheme.

A first aspect of the invention provides a publish/subscribe broker for receiving publications from at least one publisher and forwarding publications to subscribers that have registered an interest in receiving the publications. The publish/subscribe broker comprises: means for comparing a topic identifier within a received publication with topic identifiers within subscriptions that are stored at the publish/subscribe broker, to determine which subscribers the publication should be forwarded to; wherein the means for comparing comprises a set of subscription matching components and means for selecting at least one of said set of subscription matching components, wherein the means for selecting is responsive to at least one of a subscriber or the publisher specifying a required topic classification scheme.

A second aspect of the present invention provides a method for subscription matching in a publish/subscribe data processing system, wherein the subscription matching comprises comparing topic identifiers within received publications with topic identifiers within subscribers' stored subscriptions to determine whether the received publications should be forwarded to the subscribers, comprising the steps of

determining from a subscription whether the respective subscriber wishes subscription matching to implement a first publisher-specified topic classification scheme or a second topic classification scheme; and
in response to the determining step, invoking a subscription matching component to perform a subscription matching process that implements the respective one of the first and second topic classification schemes.

In a first embodiment, the publisher-specified topic classification scheme is an hierarchical topic classification scheme, and the second topic classification scheme is a non-hierarchical keyword classification scheme. In this way, if publishers specify hierarchical topic strings, the subscribers can decide whether to specify their topics of interest using a topic string that corresponds to the publishers' topic hierarchy, or alternatively using elements of the topic string as independent keywords. The publish/subscribe broker then implements a different subscription matching process in accordance with each subscriber's decision.

In one embodiment of the invention, publishers notify a publish/subscribe broker of their topic classification scheme when they first connect to the publish/subscribe broker. The broker then retains scheme information for respective publishers. In another embodiment, publishers specify their topic classification scheme (an explicit scheme definition) within each publication, or publishers may specify information for finding their scheme. In the latter example, a publication may include a Uniform Resource Identifier (URI) which is used by the broker to access XML schema information when required.

When a subscriber indicates that their subscription is intended to reflect the publisher-specified scheme, the broker invokes a subscription matching component that is specific to that scheme. For example, if a subscription indicates an intention to take account of a topic hierarchy specified by the publisher, the broker invokes a matching algorithm that compares a received publication with an hierarchical topic tree to identify relevant subscriptions—iteratively matching elements of the hierarchical topic string, level-by-level. The matching algorithm only identifies a match if the publication and the subscription include an identical hierarchical topic string (subject to wildcards and filters, as mentioned above). However, if a subscriber indicates that the elements of a topic name within a respective subscription are intended to be interpreted as a set of independent keywords, the broker invokes an appropriate subscription matching component that implements a keyword-based comparison.

This gives subscribers considerable flexibility regarding which publications they wish to receive, including whether to limit to publications that include on a precise topic string or to receive all publications on a specified set of subjects that are of interest to the subscriber. The broker is able to respond to the subscriber's requirements by selecting an appropriate subscription matching process.

In one embodiment, a single subscriber may specify more than one topic string, with the intention that a first string will be compared with publications received at the broker from a first set of publishers who implement a first classification scheme, whereas a second string will be compared with publications from a second set of publishers who implement a second classification scheme.

Similarly, a publisher may specify information in more than one format, for processing by different matching algorithms associated with different subscriptions. For example, a publication may include a topic field in which an hierarchical topic string may be specified, as welt as a tags field in which a set of one or more tags or keywords may be specified. This allows a single publication to include information in a suitable format for comparison with different subscription schemes.

A new subscriber that joins the publish/subscribe network may initially subscribe using a set of independent keywords (e.g. specifying the Boolean OR operation or a logical equivalent using a comma-delimited list) to receive publications on a number of general subjects of interest. A broker compares each of the keywords with published messages and messages that match any of the keywords are sent to the subscriber. The subscriber can then refine their subscription by selecting the most interesting publications from the received set, and selecting the topic strings of these interesting publications for use in a refined subscription or set of subscriptions. For example, the refined set of subscriptions may comprise a set of hierarchical topic strings extracted from publications that the subscriber identified as particularly helpful. This capability for a subscriber to switch between different topic classification schemes is not provided in prior art solutions.

In a similar way, an existing subscriber that is retying on an hierarchical topic string to receive a first subset of publications may wish to periodically check the publish/subscribe network for other publications of interest. This can be achieved by periodically switching their subscriptions to a less-constrained topic classification scheme. If the broader-scope subscription identifies additional publications of interest, the topic strings within these additional publications can be extracted and used to create new subscriptions including hierarchical topic strings.

The above-described examples show that there is considerable flexibility provided by the present invention—in terms of the topic classification schemes that can be catered for, and in terms of how the publishers' and subscribers' intentions may be expressed and interpreted.

Another aspect of the invention provides a data processing system for use in a publish/subscribe communications network the system comprising: means for receiving publications from one or more publishers; means for sending publications to one or more subscribers; and a publish/subscribe broker for comparing topic identifiers within received publications with topic identifiers within subscriptions that are stored at the publish/subscribe broker, to determine which publications should be sent to which subscribers; wherein the publish/subscribe broker comprises at least two subscription matching components and means for determining from a subscription whether the respective subscriber intends the brokers subscription matching to implement a first publisher-specified topic classification scheme or a second topic classification scheme; and wherein the publish/subscribe broker is responsive to the determining step to invoke a subscription matching component to perform a subscription matching process that implements the respective one of the first and second topic classification schemes.

Another aspect of the invention provides a data processing system for use in a publish/subscribe communications network, the system comprising: a data processing unit; a data storage unit; a network communication interface; and a publish/subscribe broker for receiving publications from at least one publisher and forwarding publications to subscribers that have registered an interest in receiving the publications. The publish/subscribe broker comprises: means for comparing a topic identifier within a received publication with topic identifiers within subscriptions that are stored at the publish/subscribe broker to determine which subscribers the publication should be forwarded to; wherein the means for comparing comprises a set of subscription matching components and means for selecting at least one of said set of subscription matching components, wherein the means for selecting is responsive to at least one of a subscriber or the publisher specifying a required topic classification scheme.

Embodiments of the invention may be implemented in computer program code and made available as a program product comprising program code recorded on a recording medium for controlling operations of a data processing apparatus on which the program code executes.

### BRIEF DESCRIPTION OF DRAWINGS

Embodiments of the invention are described below in more detail, by way of example, with reference to the accompanying drawings in which:

FIG. 1 is a schematic representation of a simple topic hierarchy, such as is known in the art;

FIG. 2 is a schematic representation of a publish/subscribe network such as is known in the art, in which the present invention may be implemented:

FIG. 3 is a schematic representation of an example message structure according to an embodiment of the invention;

FIG. 4 is a schematic representation of the components of a publish/subscribe broker according to an embodiment of the invention; and

FIG. 5 is a schematic flow diagram representing a subscription matching method according to an embodiment of the invention.

### DETAILED DESCRIPTION OF EMBODIMENTS

A number of embodiments of the present invention are described below in more detail, to provide an improved understanding of the invention and its advantages and possible implementations. The invention is not limited to these illustrative embodiments. The described embodiments include methods, apparatus and computer programs for subscription matching in a publish/subscribe communications environment. Activation and/or deactivation events are associated with subscriptions and are used to control when a subscription is active. Conventional subscription matching is avoided for an inactive subscription.

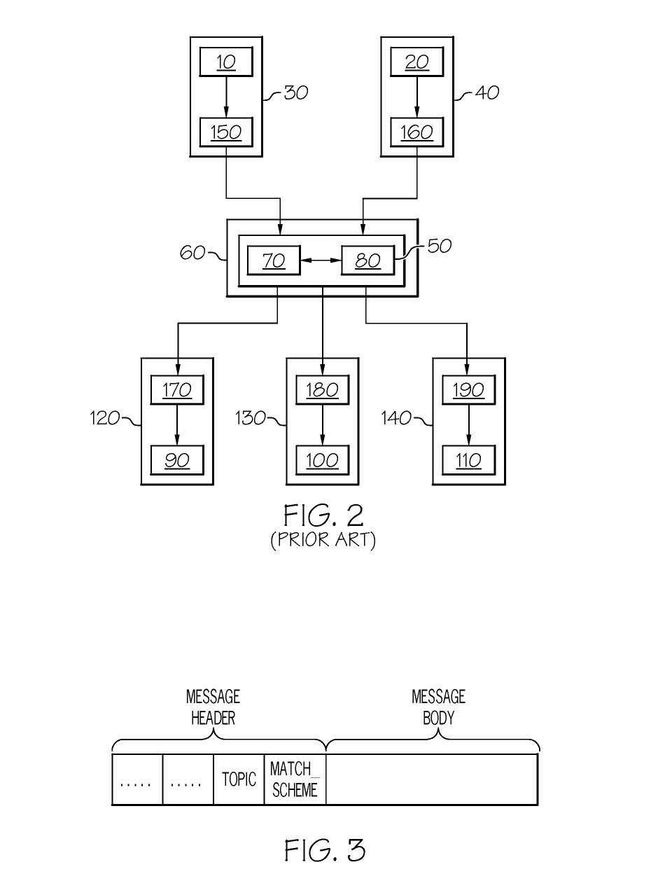

FIG. 2 shows a simple publish/subscribe messaging network in which the present invention may be implemented. Such networks are known in the art. A set of publishers 10,20 running on respective data processing systems 30,40 are able to publish messages that can be received by multiple subscribers 90, 100, 110, by the publishers sending messages to an intermediate publish/subscribe message broker 50. The publishers and subscribers do not need direct connections between them and do not need each other's address information. Instead, the publishers send messages to the broker 50, including information such as message topics within their published messages. In this example, the publishers 10,20 are application programs that rely on message transfer functions of underlying messaging infrastructure products 150,160 that hold network address and other communication information for the broker 50.

In this example, the message broker is implemented on a data processing system 60 that is separate from the publisher systems 30,40 and separate from subscriber's systems 120,130,140. The message broker comprises a subscription matching engine 70 and an associated stored subscription list 80. Subscribers register with the broker 50 and indicate their interest in particular information such as by specifying a particular message topic or topics. The subscribers' requirements are stored at the broker. In one embodiment, a broker can also store network addresses and protocol requirements for individual subscriber systems and the broker can initiate a connection; but in a preferred embodiment the broker merely stores names of subscriber systems and of their subscriptions, and the network and communications information is held at the subscriber's system and is used when the subscriber initiates a connection to the broker.

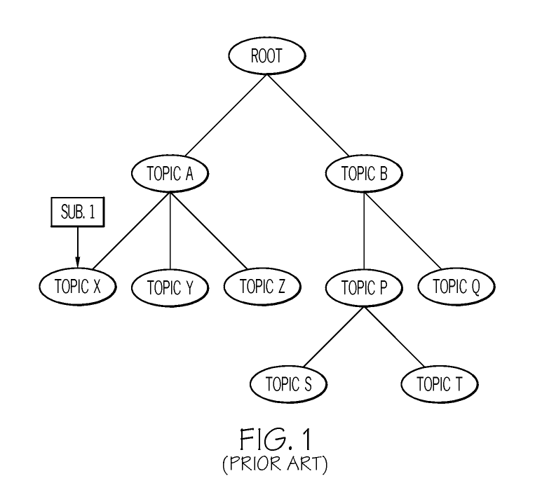

The subscription matching engine 70 at the broker 50 compares subsequently received publications with stored subscriptions to determine which received publications match the requirements of which subscribers, and the broker forwards the publications to the interested subscribers. Although only a small number of publishers and subscribers are shown in FIG. 1, there may be many publishers and many subscribers within the network and the publish/subscribe broker may be part of a distributed broker network,

For cost reasons and to facilitate ongoing development, it is common for a publish/subscribe matching engine to be implemented in computer program code. In general several elements of the invention including the described publish/subscribe broker, the publisher applications and the subscriber applications may be implemented in computer program code. This code may be written in an object oriented programming language such as C++, Java™ or SmallTalk or in a procedural programming language such as the C programming language. These program code components may execute on a general purpose computer or on a specialized data processing apparatus. As confirmed in more detail below, program code implementing some features and aspects of the invention may execute entirely on a single data processing device or may be distributed across a plurality of data processing systems within a data processing network such as a Local Area Network (LAN) a Wide Area Network (WAN), or the Internet. The connections between different systems and devices within such a network may be wired or wireless and are not limited to any particular communication protocols or data formats and the data processing systems in such a network may be heterogeneous systems.

In many cases a publish/subscribe broker will be implemented on a high capacity, high performance, network-connected data processing system—since such systems can maintain high performance publication throughput for a large number of publishers and subscribers. The publish/subscribe broker may be a component of an edge server (i.e. the broker may be one of a set of Web server or application server components) or a network gateway device. However, ‘micro broker’ solutions that have a small code footprint have been developed in recent years and have been used for example in remote telemetry applications, so it is now true to say that the publishers, subscribers and publish/subscribe broker may all be implemented on any one of a wide range of data processing systems and devices. The invention can therefore be implemented in networks that include wirelessly-connected PDAs, mobile telephones and automated sensor devices as welt as networks that include complex and high performance computer systems.

It will be clear to persons skilled in the art that various components of a distributed publish/subscribe communications network could be implemented either in software or in hardware (e.g. using electronic logic circuits). For example, a publish/subscribe matching engine 70 could be implemented by a hardware comparator that compares a topic name within a published message with a topic name within a stored subscription. The comparator's output signal indicating a match or lack of a match would then be processed within an electronic circuit to control whether or not a message is forwarded to a particular subscriber. A filtering step implemented by some publish/subscribe matching engines may be implemented by an electronic filter (a type of electronic circuit)—especially where the data values to which a filter is to be applied can be represented as signal amplitudes,

As noted above, the invention is applicable to publish/subscribe communications environments that rely on a centrally located broker (as in FIG. 1) or a distributed broker network. The invention provides particular advantages for a publish/subscribe broker that manages subscriptions for a plurality of subscribers, but the invention is also applicable in environments in which the publish/subscribe broker comprises publish/subscribe matching engine functionality that is replicated at each subscriber system.

Thus, it is clear that the present invention is applicable to a wide range of operating environments and may be implemented using various combinations of hardware and software. In each case, the invention provides increased flexibility in the specification of topics by publishers and/or subscribers, and flexibility in the subscription matching by a publish/subscribe broker, within a publish/subscribe communications network.

An embodiment of the invention is described below with reference to FIGS. 3 to 5. FIG. 3 is a schematic representation of the structure of a typical message, including a set of message header fields and a message body (the data ‘payload’ of the message). The message header may include a number of different fields including, for example: message format information; a topic field; an indication of the required quality of service (either persistent or non-persistent, to control whether the message should be saved to nonvolatile storage to be recoverable in the event of a failure), and a retain flag (to indicate whether the broker should retain a copy of this publication, to enable the latest publication for this topic to be made available to future subscribers to this topic). Additional header fields are known in the art.

For example a publisher application can invoke a send operation on an existing connection to a publish/subscribe broker to publish a message, using an API call such as:
publish(topic, data, persistence, retain)
   where each of ‘persistence’ and ‘retain’ are message properties as described above and are specified together with the topic information within header fields of the published message. The topic field of the published message may include a character string in which text elements are separated by a ‘/’ character. In a conventional publish/subscribe system implementing an hierarchical topic classification scheme, a publisher-specified topic string such as “root/topicA/topicX” is interpreted as a single hierarchical topic name and will only be identified as a match for subscriptions that specify the exact same topic string “root/topicA/topicX” (or an equivalent using wildcards such as “*/topicA/topicX” or “root/topicA/*”).

Translating from a programming API to a message header is well known in the art. For example, in some known systems, messages have a header that contains the publish/subscribe attributes in XML-like format. A message published on topic “root/topicA/topicX”, could have the following within its message header:

<psc>
<Command>Publish</Command>
<Topic>root/topicA/topicX</Topic>
</psc>

In a first embodiment of the present invention, an additional ‘match_scheme’ tag is provided within an additional field of the message header. The ‘match_scheme’ field is provided to enable a publisher to specify the topic classification scheme they have implemented when specifying a topic string within the topic field. In this exemplary embodiment, a number of topic classification schemes can be specified by publishers and will be recognized by the publish/subscribe broker, including:

‘match_scheme=OR’ which indicates that the publisher intends each of the separate elements of the specified topic string to be interpreted as independent tags (or ‘keywords’) that can be compared with subscriptions using a matching algorithm that uses the Boolean OR operator.
‘match_scheme=AND’ which indicates that the publisher intends each of the separate elements of the specified topic string to be interpreted as independent tags (or ‘keywords’) that can be compared with subscriptions using a matching algorithm that uses the Boolean AND operator,
‘match_scheme-HI’ which indicates that the publisher intends the specified topic string to be interpreted as a single hierarchical topic name that can be compared with subscriptions using an hierarchical topic matching algorithm.

Publishers can specify a topic string using the conventional format described above in which elements are separated by the ‘/’ character, and yet the intention of this topic string format can be different for different publishers. The particular publishers intent is captured within the ‘match_scheme’ value.

For example a first publisher application may specify “2012_olympics/UK_olympic_teams/sailing” with ‘match_scheme=HI’. The publisher's intention is that the broker and subscribers interpret this as the topic subcategory ‘sailing’ within category ‘UK_olympic_teams’ within the more general category ‘2012_olympics’.

A second publisher may specify the same topic string “2012_olympics/UK_olympic_teams/sailing” with ‘match_scheme=OR’, in which case this publlisher's intention is that the separate elements ‘2012_olympics’, ‘UK_olympic_teams’ and ‘sailing’ can be matched separately. That is, the publisher's intention is that a subscription to any one of the topics ‘2012_olympics’, ‘UK_olympic_teams’ and ‘sailing’ will be identified as a match for the current publication.

In another embodiment, the publishers' topic classification schemes (‘match_scheme’ values) are specified when establishing a connection to the publish/subscribe broker. This is acceptable in most cases, because the publisher's scheme is unlikely to change between successive publications, and indeed has the advantage that the broker does not have to interpret ‘match_scheme’ values dynamically on receipt of each published message

Similarly, subscribers can also specify one of a number of different topic classification schemes, which in the present embodiment include.

‘match_scheme=OR’ which indicates that the subscriber intends that each of the separate elements of the topic string specified in their subscription shall be interpreted as an independent tag that can be compared with topic information within a received publication, using a matching algorithm that uses the Boolean OR operator.
‘match_scheme=AND’ which indicates that the subscriber intends that each of the separate elements of the topic string specified in their subscription shall be interpreted as an independent tag that can be compared with topic information within a received publication, using a matching algorithm that uses the Boolean AND operator.
‘match_scheme=HI’ which indicates that the subscriber intends the specified topic string to be interpreted as a single hierarchical topic name that can be compared with received publications using an hierarchical topic matching algorithm,
‘match_scheme=PUB’ which indicates that the subscriber wishes their specified topic string to be interpreted consistently with the specified intention of the publishers (i.e. a match_scheme value of ‘OR’, ‘AND’ or ‘HI’, depending on the match_scheme value specified by the publisher).

The specified intentions of the publishers and subscribers are interpreted by the publish/subscribe broker when establishing a new connection (or on receipt of a new publication, as specified above) and are applied when performing subscription matching, as described in more detail below. If a subscriber specifies a required ‘match_scheme’ that the broker is unable to handle, a negotiation may follow to enable the subscriber to specify a matching scheme that is consistent with one of the matching algorithms supported by the broker—initially checking whether the broker is able to handle a first subscriber-specified match_scheme and then, if this is not possible, checking whether the broker is able to handle a second specified match_scheme. If the subscriber's requirement is deemed to be essential and cannot be satisfied by the broker, the subscription request may be rejected. In one embodiment, the broker may retrieve or invoke a remote matching algorithm if required.

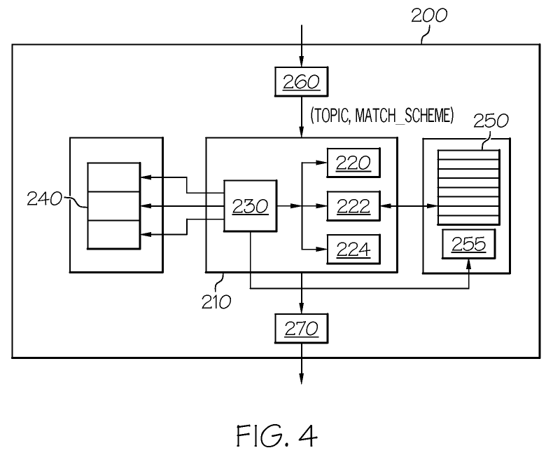

As shown in FIG. 4, a publish/subscribe message broker 200 according to a preferred embodiment of the invention includes a matching engine 210 associated with a set of matching components 220,222,224 and a matching component selector 230. A receiver component 260 for each connected publisher system comprises a communications stack and a protocol handler module for demarshalling of a received message from a received canonical byte format to the message broker's internal representation of a message. There is a corresponding transmitter component 270 for each subscriber system, for marshalling the message into canonical byte format, to allow messages to flow over the network connections. The communications stack has access to a TCP/IP socket for communication with the external network. The message broker 200 listens on a particular TCP port for newly established client connections. TCP/IP is merely one example protocol and the invention is not limited to any particular communication protocol.

On receipt of an inbound connection request, the message broker bootstraps a communications stack for that client. This stack is responsible for maintaining the connection with the client and monitoring the current state of the socket connection. The communications stack bootstraps the protocol handling module, and the protocol handling module handles the decoding and encoding of the formats and communication protocol of received messages to achieve an internal object representation that can be consumed by the message broker. For example, the protocol module will demarshal inbound messages from a publisher client into an object form and submit them to the publish/subscribe matching engine 210 for comparison with registered subscriptions, and will marshal them for delivery to subscribers. In addition, when a publisher requests a connection to the broker, the publisher also specifies its topic classification scheme as described above. The topic classification scheme for each publisher is then stored in a table 240 at the broker.

Subscribers send their subscription requests to the broker, and these subscription requests specify both a topic string and a topic classification scheme. The subscriptions are stored in a repository 250 at the broker. For each subscription for which the topic string is specified to be an hierarchical topic string, the hierarchical set of topic elements are added to a topic tree that represents the full set of hierarchical topic strings of all registered subscriptions. That is, each subscription's topic string is represented as a path within the tree (see FIG. 1). In addition to these hierarchical topic strings, any non-hierarchical strings specified by subscribers are also stored in the repository 250, together with a file 255 listing all the topic classification schemes of currently registered subscribers. In the present embodiment, the subscriptions are indexed in the repository by their ‘match_scheme’ values.

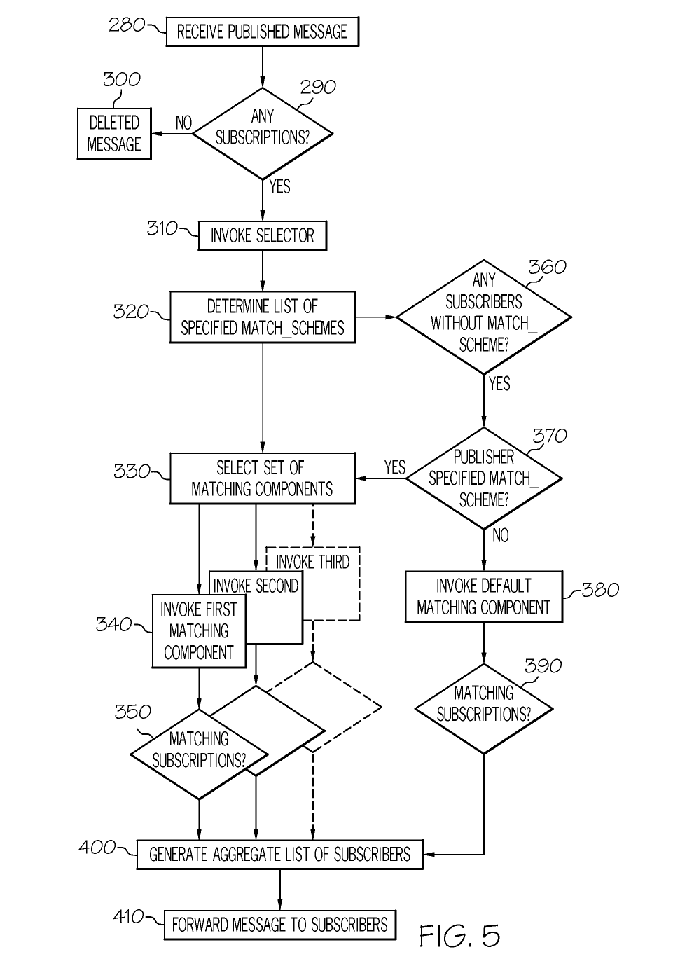

FIG. 5 shows a sequence of steps performed by the publish/subscribe broker in response to receipt of a new publication. The protocol handler module of the receiver component demarshals the message and passes the message to the publish/subscribe matching engine 210, as described above. In response to receipt 280 of a published message, an initial check is performed 290 to determine whether there are any currently registered subscriptions. If this determination is negative, the message is deleted 300. If the determination is positive, the matching component selector 230 is invoked 310 to determine an appropriate matching component or set of matching components 220,222,224 for performing subscription matching for this publication.

The ‘match_scheme’ list within the file 255 in the subscription repository 250 is checked to determine 320 whether any currently registered subscribers have specified a desired topic ‘match_scheme’ and to identify the list of schemes. If any registered subscribers have specified a requirement to interpret their topic strings in accordance with a specific topic classification scheme, the matching component selector 230 selects 330 the corresponding matching component for that scheme. The selector 230 selects an additional matching component for every topic classification scheme for which there is a current registered subscriber.

The matching engine 210 then invokes 340 each of the selected matching components in turn, and executes 350 their respective matching process against the received publication. For each selected matching component 220,222,224, the received publication is compared with every subscription that has specified the corresponding topic classification scheme (i.e. each subscription having a ‘match_scheme’ value corresponding to the respective matching component). Thus, in this embodiment the ‘match_scheme’ specified by each subscriber takes precedence over any publisher-specified ‘match_scheme’—the publisher's intent does not override explicitly specified subscriber requirements.

A check is performed 360 of whether there are any registered subscribers that have not specified a topic classification scheme or if any specified ‘match_scheme=PUB’. If this determination is positive, a determination is made 370 of whether the publisher has specified a topic classification scheme. For a publisher that has previously identified its topic classification scheme to the broker, the matching component selector retrieves the topic classification scheme from the scheme table 240, and the matching component selector 230 selects 330 a matching component that implements a matching algorithm consistent with the publisher-specified topic classification scheme.

If any one of the subscribers did not specify a ‘match_scheme’ value and the publisher has not specified a ‘match_scheme’ value, the publish/subscribe broker assumes that a default topic classification scheme is to be used, which in the present example embodiment is an hierarchical topic naming scheme. The matching engine invokes 380 a default matching component for this topic naming scheme. This matching component executes its matching process to check 390 for matching subscriptions.

The identified set of subscribers resulting from execution of each of the invoked matching component is then combined 400 with the set of subscribers identified by the other matching components. The message is then forwarded 410 to the aggregate set of matching subscribers.

Although particular exemplary embodiments of the invention have been described in detail the present invention is not limited to this particular embodiment and encompasses all embodiments that are within the scope of the following claims, Persons skilled in the art will recognize that various enhancements and modifications can be made to the described embodiments within the scope of the present invention.

We claim:

1. A method for subscription matching in a publish/subscribe data processing system, wherein the subscription matching comprises comparing topic identifiers within received publications with topic identifiers within subscribers' stored subscriptions to determine whether the received publications should be forwarded to the subscribers, comprising the steps of:
determining from a subscription whether a respective subscriber wishes subscription matching to implement a first topic classification scheme or a second topic classification scheme; and
in response to the determining step, invoking a subscription matching component to perform a subscription matching process that implements the respective one of the first and second topic classification schemes.

2. A method according to claim 1 further comprising:
identifying a set of required topic classification schemes for a set of subscribers; for each of the identified set of required topic classification schemes, invoking a subscription matching component to perform a subscription matching process that implements the respective topic classification scheme; and
aggregating the results of the subscription matching processes to identify an aggregate set of subscribers to which the publication should be forwarded.

3. A method according to claim 1, wherein the first topic classification scheme is a publisher-specified topic classification scheme.

4. A method according to claim 3, wherein the publisher-specified topic classification scheme is specified to the publish/subscribe broker during establishment of a connection between the publisher and the publish/subscribe broker.

5. A method according to claim 3, wherein the publisher-specified topic classification scheme is specified within a published message.

6. A method according to claim 3, wherein the publisher-specified topic classification scheme is referenced by a URI within a published message.

7. A method according to claim 3, wherein a determination is made that the subscriber wishes subscription matching to apply the publisher-specified topic classification scheme in the absence of an explicit subscriber-specified request for subscription matching to implement any alternative topic classification scheme.

8. A publish/subscribe broker for receiving publications from at least one publisher and forwarding publications to subscribers that have registered an interest in receiving the publications, the publish/subscribe broker comprising: means for comparing a topic identifier within a received publication with topic identifiers within subscriptions that are stored at the publish/subscribe broker, to determine to which subscribers the publication should be forwarded;
wherein the means for comparing comprises a set of subscription matching components and means for selecting at least one of said set of subscription matching components, wherein the means for selecting is responsive to at least one of a subscriber or the publisher specifying a required topic classification scheme.

9. A publish/subscribe broker according to claim 8, wherein the means for selecting selects a subscription matching component implementing a respective topic classification scheme for each topic classification scheme specified by any subscriber.

10. A publish/subscribe broker according to claim 9, wherein the means for selecting selects a subscription matching component implementing a publisher-specified topic classification scheme in response to identifying a subscription that does not specify a topic classification scheme.

11. A data processing system for use in a publish/subscribe communications network, the system comprising:
a data processing unit;
a data storage unit-
a network communication interface; and
a publish/subscribe broker for receiving publications from at least one publisher and forwarding publications to subscribers that have registered an interest in receiving the publications, wherein the publish/subscribe broker comprises: means for comparing a topic identifier within a received publication with topic identifiers within subscriptions that are stored at the publish/subscribe broker, to determine which subscribers the publication should be forwarded to;
wherein the means for comparing comprises a set of subscription matching components and means for selecting at least one of said set of subscription matching components, wherein the means for selecting is responsive to at least one of a subscriber or the publisher specifying a required topic classification scheme.

12. A computer program product, comprising program code recorded on a recording medium for controlling operations within a data processing apparatus on which the program runs, wherein the program code comprises:
code means for receiving publications from at least one publisher and forwarding publications to subscribers that have registered an interest in receiving the publications; and
code means for comparing a topic identifier within a received publication with topic identifiers within stored subscriptions, to determine which subscribers the publication should be forwarded to;
code means for determining from a subscription whether a respective subscriber wishes subscription matching to implement a first topic classification scheme or a second topic classification scheme; and
code means for invoking a subscription matching component to perform a subscription matching process that implements the respective one of the first and second topic classification schemes.

13. The computer program product of claim 12, wherein the code means for comparing comprises a set of subscription matching components and code means for selecting at least one of said set of subscription matching components, wherein the means for selecting is responsive to at least one of a subscriber or the publisher specifying a required topic classification scheme.

14. The computer program product of claim 12, further comprising:
code means for identifying a set of required topic classification schemes for a set of subscribers;
for each of the identified set of required topic classification schemes, code means for invoking a subscription matching component to perform a subscription matching process that implements the respective topic classification scheme; and
code means for aggregating the results of the subscription matching processes to identify an aggregate set of subscribers to which the publication should be forwarded.

15. The computer program product of claim 12, wherein the first topic classification scheme is a publish/specified topic classification scheme.

16. The computer program product of claim 15, wherein the publisher-specified topic classification scheme is specified to the publish/subscribe broker during establishment of a connection between the publisher and the publish/subscribe broker.

17. The computer program product of claim 15, wherein the publisher-specified topic classification scheme is specified within a published message.

18. The computer program product of claim 15, wherein the publisher-specified topic classification scheme is referenced by a URI within a published message.

19. The computer program product of claim 15, wherein a determination is made that the subscriber wishes subscription matching to apply the publisher-specified topic classification scheme in the absence of an explicit subscriber-specified request for subscription matching to implement any alternative topic classification scheme.
